(19) United States
(12) Patent Application Publication
(10) Pub. No.: US 2026/0365099 A1
(43) Pub. Date: Nov. 19, 2026

(54) MULTIPURPOSE MODULE FOR A MOBILITY VEHICLE

(71) Applicants: HYUNDAI MOTOR COMPANY, Seoul (KR); KIA CORPORATION, Seoul (KR); KWANG MYUNG IND. CO., LTD., Gwangmyeong-si (KR); HYUNDAI TRANSYS INC., Seosan-si (KR)

(72) Inventors: Jung Hoon Woo, Hwaseong-si (KR); Ji Yun Ha, Hwaseong-si (KR); Soo Bok Kim, Hwaseong-si (KR); Byung Hoon Yoo, Seongnam-si (KR); Min Ho Kang, Hwaseong-si (KR); Tae Hun Cheon, Seongnam-si (KR); Jong Seon Lee, Hwaseong-si (KR); Jae Yong Jang, Suwon-si (KR); Ki Young Yun, Yongin-si (KR); In Gul Baek, Yongin-si (KR); Kook Hee Lee, Suwon-si (KR)

(73) Assignees: HYUNDAI MOTOR COMPANY, Seoul (KR); KIA CORPORATION, Seoul (KR); KWANG MYUNG IND. CO., LTD., Gwangmyeong-si (KR); HYUNDAI TRANSYS INC., Seosan-si (KR)

(21) Appl. No.: 19/386,930

(22) Filed: Nov. 12, 2025

(30) Foreign Application Priority Data
May 14, 2025 (KR) 10-2025-0062739

(51) Int. Cl. B60P 7/08; B60N 2/04

(52) U.S. Cl. CPC B60P 7/0815; B60N 2/04

(57) ABSTRACT

A multipurpose module for a mobility vehicle configured to improve use convenience of an auxiliary device, such as a seat or a rack, by allowing the auxiliary device to move to various locations along a path part inside the mobility vehicle, and to improve the productivity of the mobility vehicle by allowing a passenger to freely change an indoor space of the mobility vehicle to increase indoor space utilization.

### CROSS REFERENCE TO RELATED APPLICATION

The present application claims the benefit of and priority to Korean Patent Application No. 10-2025-0062739, filed May 14, 2025, the entire contents of which are hereby incorporated herein for all purposes by reference.

### BACKGROUND

### Technical Field

The present disclosure relates to a multipurpose module for a mobility vehicle, the multipurpose module allowing an auxiliary device, such as a seat or a rack, to move to various locations inside a mobility vehicle.

### Description of the Related Art

A mobility vehicle that moves with boarded passengers includes various parts, such as seats for passengers to sit on, racks, and armrests to improve the comfort of passengers.

Furthermore, a larger mobility vehicle may require an increased number of seats, racks, and armrests, due to an increased number of passengers, and other convenient devices may be provided.

Conventionally, seats and other convenient devices are fixed in locations where the devices were originally designed. Accordingly, the interior space of a mobility vehicle may be limited, and passengers may have difficulty using each convenient device.

The matters described above as background technology are intended to provide a better understanding of the context of the present disclosure and are not intended to constitute a disclaimer of the prior art known to those of ordinary skill in the art.

### SUMMARY

An objective of the present disclosure is to provide a multipurpose module for a mobility vehicle, the multipurpose module allowing an auxiliary device, such as seats or racks, to move to various locations inside the mobility vehicle to improve the convenience of passengers and the productivity of the mobility vehicle.

The technical problem to be achieved in the present disclosure is not limited to the above technical problem, and other problems not mentioned should be clearly understood by those having ordinary skill in the art from the description below.

In order to achieve the above-described objective, according to an embodiment of the present disclosure, there is provided a multipurpose module for mobility vehicle, the multipurpose module including: a first rail providing a first path on which a transfer unit installed at an auxiliary device is movable in a first direction; a second rail providing a second path on which the transfer unit is movable in another (i.e., second) direction different from the first rail, and disposed to create a connection point with the first rail; and a connecting block provided at the connection point of the first rail and the second rail and connecting the first rail and the second rail to each other, thereby allowing the transfer unit to move in an extension direction of the first rail and an extension direction of the second rail.

According to the embodiment, the first rail and the second rail may extend in directions orthogonally to each other.

According to the embodiment, the connecting block may be installed or disposed at the connection point, in which an end portion of the first rail and an end portion of the second rail match each other, at an indoor bottom portion of the mobility vehicle, and a portion of a circumferential surface of the connecting block may overlap with the end portion of the first rail and the end portion of the second rail.

According to the embodiment, the connecting block may include coupling portions on the circumferential surface thereof, and the coupling portions may be coupled to the first rail and the second rail and extend into lower spaces or portions of the end portion of the first rail and the end portion of the second rail.

According to the embodiment, lower portions of the end portions of the first rail and the second rail may be recessed or depressed to form coupling grooves, and the coupling portions of the connecting block may be provided to be inserted into the coupling grooves below the end portion of the first rail and the end portion of the second rail.

According to the embodiment, contact portions of the coupling grooves and the coupling portions may be formed into angulated or curved shapes.

According to the embodiment, the first rail may be installed or disposed at an indoor bottom portion of the mobility vehicle and include a first gear part formed at an upper portion to guide the transfer unit to move in the extension direction of the first rail, the second rail may be installed at the indoor bottom portion of the mobility vehicle and include a second gear part formed at an upper portion to guide the transfer unit to move in the extension direction of the second rail, and the connecting block may include a third gear part connecting the first gear part and the second gear part to each other.

According to the embodiment, each of the first gear part and the second gear part may extend in a direction crossing the extension direction of each rail, and the third gear part protrude in a grid shape with intervals inside the connecting block.

According to the embodiment, the first gear part and the second gear part may have sectional shapes with inclined side surfaces, and the third gear part may have a section in the extension direction of the first rail and a section in the extension direction of the second rail, and the sections may be formed equal to each other.

According to the embodiment, the transfer unit may include a first transfer unit connected to the first gear part and moving along the first rail and a second transfer unit connected to the second gear part and moving along the second rail.

According to the embodiment, the first transfer unit may include a first connection part engaged with the first gear part and a first driving part selectively transferring or moving the first connection part so that the first connection part may be selectively engaged with the first gear part, and the second transfer unit may include a second connection part engaged with the second gear part and a second driving part selectively transferring or moving the second connection part so that the second connection part may be selectively engaged with the second gear part.

According to an embodiment, the first gear part and the second gear part may include rack gears, and the first connection part and the second connection part may include at least one of a helical gear, a screw gear, or a pinion gear.

According to the embodiment, at an indoor bottom portion of the mobility vehicle, a plurality of installation holes may be formed at positions where extension paths of the first rail and the second rail may be provided and the connecting block is provided, lower surfaces of the first rail, the second rail, and the connecting block may include fastening holes that match the installation holes, and fixing pins may be inserted into the installation holes and the fastening holes so that the first rail, the second rail, and the connecting block may be fixed to the indoor bottom portion of the mobility vehicle.

According to the embodiment, an indoor bottom portion of the mobility vehicle may include a path part extending along the extension direction of the first rail and the extension direction of the second rail, and the auxiliary device may include a moving member moving along the path part.

According to the embodiment, the path part may include a pair of wall parts, and the pair of wall parts may provide a path along which the moving member may be movable between the wall parts.

According to the embodiment, the moving member may include a plurality of damping parts on a circumferential surface thereof, and at least one damping part may come into contact with each wall part of the path part.

According to the embodiment, a lower surface of the moving member may include a rolling part which is rollable in at least one direction to roll on the indoor bottom portion of the mobility vehicle.

According to the embodiment, the path part may have a height formed from the indoor bottom portion of the mobility vehicle higher than the first rail, the second rail, and the connecting block.

According to the above-described multipurpose module for a mobility vehicle of the present disclosure, the location of the auxiliary device, such as a seat or a rack, is changed to various locations along the path part inside the mobility vehicle so that the use convenience of the auxiliary device can be improved, and a passenger can freely change the indoor space of the mobility vehicle to increase indoor space utilization so that the productivity of the mobility vehicle can be improved.

The effect of the present disclosure is not limited to the above-mentioned effects, and other effects not mentioned should be clearly understood by those having ordinary skill in the art from the description below.

### BRIEF DESCRIPTION OF THE DRAWINGS

FIG. 1 is a view showing a multipurpose module for a mobility vehicle according to an embodiment of the present disclosure.

FIG. 2 is a view showing a first rail, a second rail, and a connecting block according to an embodiment of the present disclosure.

FIG. 3 is a view showing arrangement of each rail according to an embodiment of the present disclosure.

FIG. 4 is a view showing installation of the first rail, the second rail, and the connecting block according to an embodiment of the present disclosure.

FIG. 5 is a view showing mounting of each rail and the connecting block according to an embodiment of the present disclosure.

FIG. 6 is a view showing a first transfer unit according to an embodiment of the present disclosure.

FIG. 7 is a view showing a second transfer unit according to an embodiment of the present disclosure.

FIG. 8 is a view showing a connection part according to an embodiment of the present disclosure.

FIG. 9 is a view showing a path part and a moving member according to an embodiment of the present disclosure.

FIG. 10 is a view showing the moving member according to an embodiment of the present disclosure.

### DETAILED DESCRIPTION

In the following description, if it is decided that the detailed description of known technologies related to the present disclosure makes the subject matter of the embodiment described herein unclear, the detailed description is omitted. In addition, the accompanying drawings are merely intended to be able to readily understand the embodiments disclosed herein, and thus the technical idea disclosed herein is not limited by the accompanying drawings, and it should be understood to include all changes, equivalents, and substitutions included in the idea and technical scope of the present disclosure. The following description is not intended to limit the present disclosure to the precise forms or particular fields of use disclosed. It is contemplated that various alternative embodiments and modifications to the present disclosure are possible, whether explicitly set forth or implied herein. A person of ordinary skill in the art will recognize that changes may be made in form and detail without departing from the scope of the present disclosure.

The present disclosure is described with reference to specific embodiments. However, as should be appreciated by one of ordinary skill in the art to which the present disclosure pertains, various embodiments disclosed herein can be modified or otherwise implemented in various other ways without departing from the spirit and scope of the present disclosure. Accordingly, the following description is to be considered illustrative and is for the purpose of teaching those having ordinary skill in the art the manner of making and using various embodiments of the present disclosure. It is to be understood that the forms of disclosure herein shown and described are to be taken as representative embodiments. Equivalent elements, materials, processes or steps may be substituted for those representatively illustrated and described herein. Expressions such as “including”, “comprising”, “incorporating”, “consisting of”, “have”, and “is” used to describe and claim the present disclosure are intended to be construed in a non-exclusive manner, namely allowing for items, components or elements not explicitly described also to be present. Additionally, reference to the singular is also to be construed to relate to the plural.

Further, various embodiments disclosed herein are to be taken in the illustrative and explanatory sense, and should in no way be construed as limiting of the present disclosure. All joining references (e.g., attached, affixed, coupled, connected, and the like) are only used to aid the reader's understanding of the present disclosure, and may not create limitations, particularly as to the position, orientation, or use of the elements and/or methods disclosed herein. Therefore, joining references, if any, are to be construed broadly. Moreover, such joining references do not necessarily infer that two elements are directly connected to each other. Additionally, all numerical terms, such as, but not limited to, “first”, “second”, “third”, “primary”, “secondary”, “main” or any other ordinal and/or cardinal terms, should also be taken only as identifiers, to assist the reader's understanding of the various elements, embodiments, variations and/or modifications of the present disclosure, and may not create any limitations, particularly as to the order, or preference, of any element, embodiment, variation, and/or modification. In other words, these expressions can be used to describe various elements, but the elements are not limited by these expressions. These expressions are only used to distinguish one element from another element.

The suffixes “module” and “part” for the components used in the following description are given or mixed in consideration of only the ease of writing the specification, and do not have distinct meanings or roles by themselves.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element intervening therebetween.

Furthermore, a unit or a control unit included in names is only a widely used term for a controller that controls a specific function of a vehicle, and does not mean a generic function unit. When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

In any of the configurations described in the specification, any number of components or a variety of components may be included within the present disclosure described herein. The components may include any combination of the features described herein and may be arranged in any of the various configurations described herein. In addition to structures and arrangements of the components of the present disclosure, the concept of use and operation thereof may be applied not only to the specific embodiments disclosed herein, but also to any number of embodiments in any combination. The embodiments including various features of various arrangements are described below with reference to the drawings.

Hereafter, the various embodiments of the present disclosure are described in detail with reference to the accompanying drawings, and the same or similar components are given the same reference numerals regardless of the numbers of figures and are not repeatedly described.

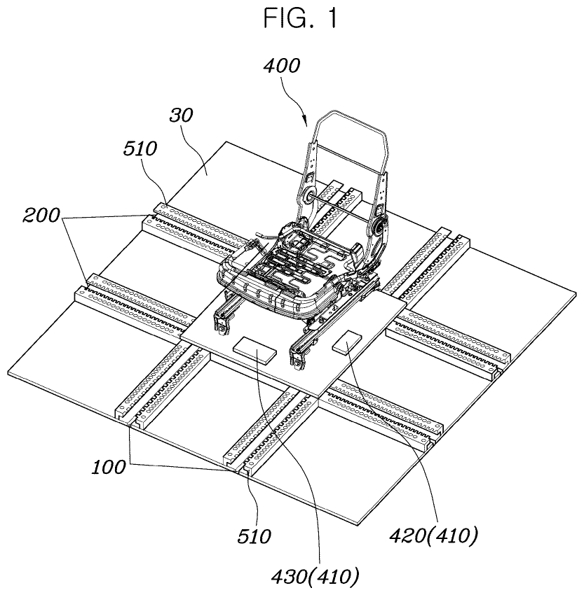

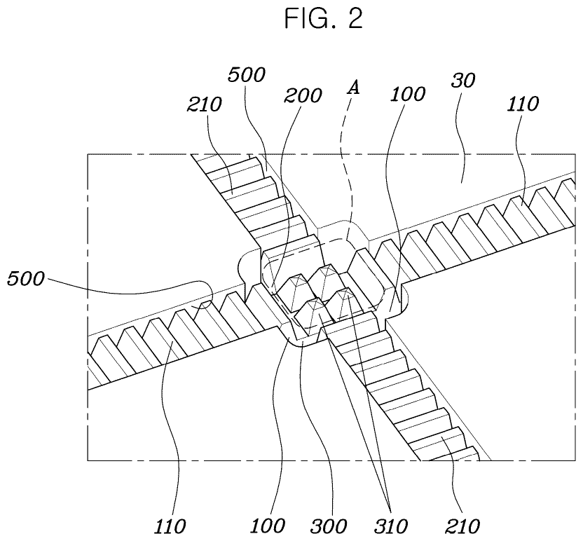

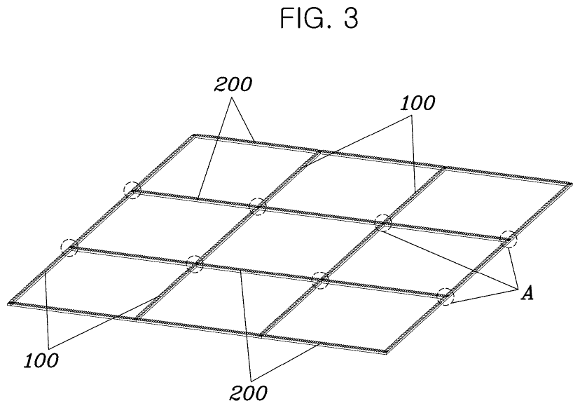

According to the present disclosure, as shown in FIG. 1, FIG. 2 and FIG. 3, a multipurpose module for a mobility vehicle may include: a first rail 100 providing a path along which a transfer unit 410 installed at an auxiliary device 400 is movable in one direction (i.e., a first direction); a second rail 200 providing a path along which the transfer unit 410 is movable in a direction (i.e., second direction) different from the first rail 100 and disposed to create a connection point A together with the first rail 100; and a connecting block 300 provided at the connection point A of the first rail 100 and the second rail 200 and connecting the first rail 100 and the second rail 200 to each other, so that the transfer unit 410 is movable in an extension direction of the first rail 100 and an extension direction of the second rail 200.

A mobility vehicle may be a means of transportation that provides a space for a passenger to sit therein, and for example, may be a vehicle.

In this mobility vehicle, the auxiliary device 400, such as seats, racks, and storage compartments, may provide various conveniences.

According to the present disclosure, the transfer unit 410 is provided in the auxiliary device 400, and the transfer unit 410 may change the location of the auxiliary device 400 by moving along each rail. The transfer unit 410 may include transfer units 410 moving along the first rail 100 and the second rail 200, and one transfer unit 410 may be provided to be movable along both the first rail 100 and the second rail 200.

The first rail 100 and the second rail 200 extend on a surface or bottom 30 (of an interior of the mobility vehicle) to create paths, and the first rail 100 and the second rail 200 create at least one connection point A to allow the transfer unit 410 to move along the first rail 100 and the second rail 200. The first rail 100 and the second rail 200 may extend along and be depressed on the bottom 30, and a mat cut along an extending line of each rail may be provided on the first rail 100 and the second rail 200.

Specifically, in the present disclosure, the connecting block 300 is provided at the connection point A of the first rail 100 and the second rail 200. In other words, the first rail 100 and the second rail 200 extend in different directions from each other, and an end of one rail is provided adjacent to an end of the other rail. The connection point A is provided at a location where the ends of the rails are connected. In other words, a plurality of first rails 100 and a plurality of second rails 200 are provided, and each of the rails creates paths, and the spacing occurring as the rails create a path may be the connection point A. When the transfer unit 410 passes through the connection point A, the spacing of the connection point A may cause an operational impact or damage to components due to the impact.

Therefore, according to the present disclosure, the connecting block 300 is provided at the connection point A and connects the first rail 100 and the second rail 200 to each other, thereby allowing the transfer unit 410, which moves along the first rail 100 and the second rail 200, to move smoothly without trapping, and ensure the durability of each component by eliminating impact occurrence.

The connecting block 300 may have an exterior shape that matches the shape of the connection point A of the first rail 100 and the second rail 200.

Furthermore, the extension directions of the first rail 100 and the second rail 200 may be designed variously depending on the interior space of a mobility vehicle.

In one embodiment of the present disclosure, the first rail 100 and the second rail 200 may extend orthogonally to each other.

The first rail 100 and the second rail 200 extend linearly, respectively, and are disposed to create the connection point A at one or more locations, thereby allowing the transfer unit 410 to move in various directions through the first rail 100 and the second rail 200.

Furthermore, the first rail 100 and the second rail 200 extend orthogonally to each other to be intuitive, thereby ensuring user convenience.

The first rail 100 and the second rail 200 may extend into various shapes, and additional rails may be used to provide various paths.

For a better understanding of the present disclosure, the first rail 100 and the second rail 200 extend orthogonally to each other. Accordingly, as shown in FIG. 3, the first rail 100 and the second rail 200 may be connected orthogonally to each other to extend into a grid. Otherwise, the first rail 100 and the second rail 200 may be arranged variously on the bottom 30 of a mobility vehicle, thereby allowing the auxiliary device 400 to move to various locations on the mobility vehicle. The arrangement of the first rail 100 and the second rail 200 is not limited to the embodiment discussed above, and may be applied to the bottom 30 of the interior of the mobility vehicle in various embodiments.

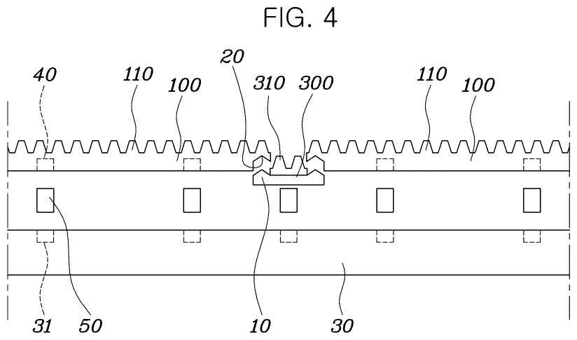

As shown in FIG. 4, the bottom 30 includes multiple installation holes 31 on the extension paths of the first rail 100 and the second rail 200 and on the location with the connecting block 300. Lower surfaces of the first rail 100, the second rail 200, and the connecting block 300 include fastening holes 40 matching the installation holes 31, and fixing pins 50 are inserted into the installation holes 31 and the fastening holes 40, so that the first rail 100, the second rail 200, and the connecting block 300 may be fixed to the bottom 30.

The bottom 30 of a mobility vehicle may have the multiple installation holes 31, and the multiple installation holes 31 may be spaced from each other at certain intervals to match the shapes of the first rail 100 and the second rail 200, which are to be installed at the bottom 30. Furthermore, a part of the installation holes 31 is formed at the connection point A of the first rail 100 and the second rail 200 at the bottom 30 to match the connecting block 300. As described above, the installation holes 31 are formed to match the first rail 100, the second rail 200, and the connecting block 300 along each of the paths, and the first rail 100, the second rail 200, and the connecting block 300 include the fastening holes 40 matching the installation holes 31. As the fixing pins 50 are inserted into the installation holes 31 and the fastening holes 40, the first rail 100, the second rail 200, and the connecting block 300 may be fixed to the bottom 30.

The fixing pins 50 may be inserted into and coupled to the installation holes 31 and the fastening holes 40. As the first rail 100, the second rail 200, and the connecting block 300 are fixed to the bottom 30 with the fixing pins 50, the installation process of the first rail 100, the second rail 200, and the connecting block 300 may be simplified, and locations of the first rail 100, the second rail 200, and the connecting block 300 may be fixed firmly.

The connection point A of the first rail 100 and the second rail 200 may include the connecting block 300. The connecting block 300 is installed at the connection point A, where an end of the first rail 100 and an end of the second rail 200 match each other on the bottom 30, and a portion of a circumferential surface of the connecting block 300 may overlap with the end of the first rail 100 and the end of the second rail 200.

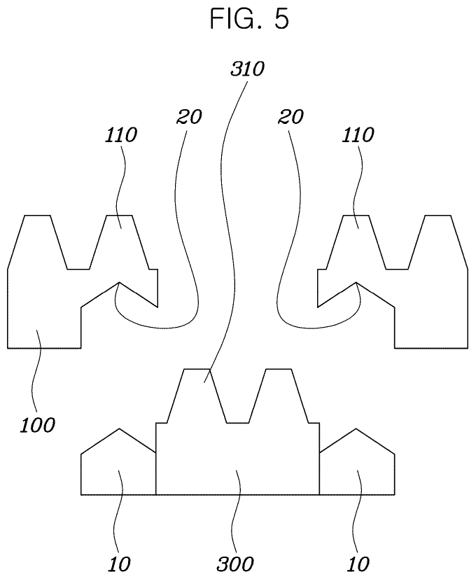

As shown in FIG. 5, since a portion of the circumferential surface of the connecting block 300 is formed to overlap with the end of the first rail 100 and the end of the second rail 200, when the connecting block 300 is disposed at the connection point A of the first rail 100 and the second rail 200, the connecting block 300 may be supported by the first rail 100 and the second rail 200 so that separation thereof from the connection point A is prevented.

As an example, as shown in FIG. 2, when two first rails 100 and two second rails 200 create one connection point A with paths in four directions, the connecting block 300 may be connected to each rail by creating an overlapping structure against each rail.

Specifically, as shown in FIG. 5, the connecting block 300 includes coupling portions 10 on the circumferential surface thereof, the coupling portions 10 being coupled to the first rail 100 and the second rail 200. The coupling portions 10 may extend toward lower portions of the end of the first rail 100 and the end of the second rail 200.

The coupling portions 10 may respectively extend from the connecting block 300 toward each rail that forms the connection point A, and may be connected to each rail while forming the overlapping structure against the end of each rail.

Furthermore, since the connecting block 300 is connected to the first rail 100 and the second rail 200 with the coupling portions 10 overlapping with the first rail 100 and the second rail 200, the location of the connecting block 300 is restricted in the longitudinal direction of each rail, and gap occurrence is minimized to prevent noise occurring by a gap when each rail and the connecting block 300 are connected to each other.

As an embodiment of the above-described overlapping structure between the connecting block 300 and each rail, lower portions of the ends of the first rail 100 and the second rail 200 are recessed or depressed to form coupling grooves 20, and the coupling portions 10 of the connecting block 300 may be formed and configured to be inserted into the coupling grooves 20 at lower portions of the ends of the first rail 100 and the second rail 200.

The exterior shape of the connecting block 300 is formed to match the end of the first rail 100 and the end of the second rail 200 at the connection point A formed by the first rail 100 and the second rail 200. The coupling portions 10 extend to be located below the coupling grooves 20 formed at the end of the first rail 100 and the end of the second rail 200. As described above, the coupling portions 10 of the connecting block 300 are disposed at lower portions of the coupling grooves 20 of the first rail 100 and the second rail 200, allowing the connecting block 300 to be caught by the first rail 100 and the second rail 200 and preventing the connecting block 300 from being separated. Furthermore, as the connecting block 300 is formed such that the coupling portions 10 are inserted into the lower portions of the coupling grooves 20 of the first rail 100 and the second rail 200, gaps between the connecting block 300, the first rail 100, and the second rail 200 may be minimized.

Furthermore, contact portions of the coupling grooves 20 and the coupling portions 10 may have angulated or curved shapes or profiles.

As an example, as shown in FIG. 5, the coupling grooves 20 (or a surface, such as a bottom surface, of the coupling grooves 20) are depressed or recessed upward in an angulated shape, and the coupling portions 10 protrude upward in an angulated shape. Therefore, when the coupling portions 10 are inserted from below the coupling grooves 20, the connecting block 300 is restricted vertically against each rail, and movement in a longitudinal direction of each rail is restricted to maintain the connecting block 300 in the location thereof.

Furthermore, the coupling portions 10 of the connecting block 300 are inserted into the coupling grooves 20 of the rails to minimize the gap between the connecting block 300 and each rail, and achieve an inter-coupling state that stabilizes the structure.

The first rail 100 is installed on the bottom 30 and includes a first gear part 110 at an upper portion thereof to guide the transfer unit 410 to move in the extension direction (i.e., a direction in which the first rail 100 extends). The second rail 200 is installed on the bottom 30 and includes a second gear part 210 at an upper portion thereof to guide the transfer unit 410 to move in the extension direction (i.e., a direction in which the second rail 200 extends). Furthermore, the connecting block 300 may include a third gear part 310 that connects the first gear part 110 and the second gear part 210 to each other, such that the first gear part 110, third gear part 310, and second gear part 210 form a contiguous path of gear parts.

The first gear part 110 of the first rail 100 and the second gear part 210 of the second rail 200 may include multiple teeth, and tooth shapes of the first gear part 110 and the second gear part 210 are equal to each other (i.e. same size, shape, and the like), and the transfer unit 410 may engage with each gear part and move along each rail.

The third gear part 310 of the connecting block 300 may be formed to allow the transfer unit 410 to move in both the extension direction of the first rail 100 and the extension direction of the second rail 200. In other words, the third gear part 310 of the connecting block 300 includes multiple teeth, but the third gear part 310 may have a shape that protrudes upward, not a shape that extends in one direction.

Specifically, as shown in FIG. 2, the first gear part 110 and the second gear part 210 may extend in directions orthogonal to the extension directions of the rails. In other words, as the first rail 100 and the second rail 200 are rack gears, the first gear part 110 and the second gear part 210 may have bar shapes. For this reason, when the transfer unit 410 moves while being engaged with the first rail 100 and the second rail 200, the transfer unit 410 may extend linearly only in the extension direction of the first rail 100 or the second rail 200.

The third gear part 310 may protrude in a grid shape having intervals therein, within the connecting block 300. In other words, the third gear part 310 may include multiple protrusions, and each protrusion is disposed while being spaced apart from another protrusion at a certain interval in a grid shape. The protrusions of the third gear part 310 are smaller than the first gear part 110 and the second gear part 210, and are spaced from each other in the extension directions of the first gear part 110 and the second gear part 210. Therefore, when the transfer unit 410 passes through the connecting block 300, the transfer unit 410 may move in both the extension direction of the first rail 100 and the extension direction of the second rail 200.

As an example, the first gear part 110 and the second gear part 210 have sectional shapes with inclined side surfaces, and a section in the extension direction of the first rail 100 and a section in the extension direction of the second rail 200 of the third gear part 310 may be formed equally.

In other words, as the first gear part 110 and the second gear part 210 extend linearly to match the shape of a rack gear, and as the sectional shape thereof has inclined surfaces on both sides, the width thereof may be reduced in an upward direction. The third gear part 310 protrudes upward from the connecting block 300, and sectional shapes in all directions have inclined side surfaces so that the width thereof may be reduced in the upward direction. In other words, the section in the extension direction of the first rail 100 and the section in the extension direction of the second rail 200 of the third gear part 310 are formed to match the sectional shapes of the first gear part 110 and the second gear part 210. Therefore, when the transfer unit 410 passes through the connecting block 300, the transfer unit 410 is movable in all directions of the first rail 100 and the second rail 200.

Accordingly, the transfer unit 410 may move linearly on the first rail 100 or the second rail 200, and the connecting block 300 provided at the connection point A of the first rail 100 and the second rail 200 is configured to allow the transfer unit 410 to move in all directions of the first rail 100 and the second rail 200, so that the transfer unit 410 may move along each rail by the connecting block 300. A gap occurring at the connection point A of each rail is filled by the connecting block 300 so that the transfer unit 410 may move smoothly without trapping.

As shown in FIG. 1, the transfer unit 410 may include a first transfer unit 420 connected to the first gear part 110 and configured to move along the first rail 100, and a second transfer unit 430 connected to the second gear part 210 and configured to move along the second rail 200.

In other words, since the transfer unit 410 includes the first transfer unit 420 connected to the first rail 100 and the second transfer unit 430 connected to the second rail 200, when the first transfer unit 420 moves, the auxiliary device 400 may move along the first rail 100, and when the second transfer unit 430 moves, the auxiliary device 400 may move along the second rail 200.

The first transfer unit 420 and the second transfer unit 430 may be connected selectively to each rail, and when the first transfer unit 420 and the second transfer unit 430 are engaged with each rail, the first transfer unit 420 and the second transfer unit 430 generate a rotary force to move along each rail.

In one embodiment of the transfer unit 410, the first transfer unit 420 may include a first connection part 421 that is engaged with the first gear part 110 and a first driving part 422 that selectively moves the first connection part 421, so that the first transfer unit 420 may be selectively engaged with the first gear part 110.

Furthermore, the second transfer unit 430 may include a second connection part 431 that is engaged with the second gear part 210 and a second driving part 432 that selectively moves the second connection part 431, so that the second transfer unit 430 may be selectively engaged with the second gear part 210.

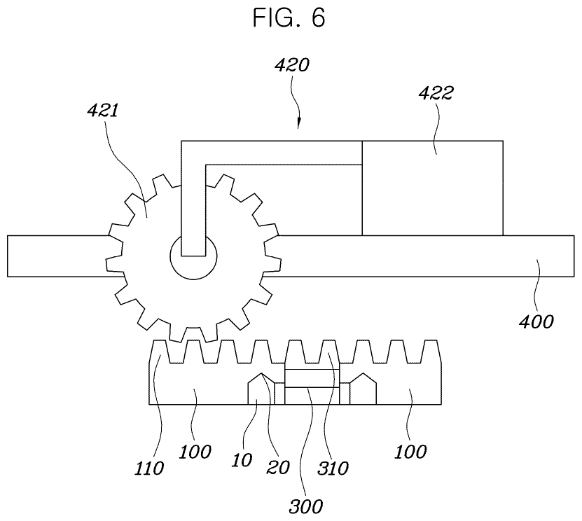

As shown in FIG. 6, the first transfer unit 420 includes the first connection part 421 and the first driving part 422. The first connection part 421 may be rotatably engaged with the first gear part 110 of the first rail 100, and the first driving part 422 may be configured so that the first connection part 421 is selectively engaged with the first gear part 110.

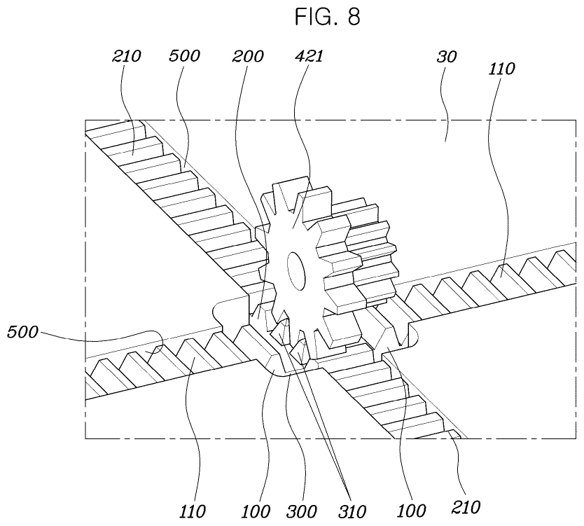

The first gear part 110 may be a rack gear in one example of the present disclosure, and the first connection part 421 may be a gear that moves by the rotary motion when engaged with the rack gear. For example, as shown in FIG. 8, the first connection part 421 may be a pinion gear and may include various gears, such as a helical gear or a screw gear. In addition, various embodiments of the first connection part 421 may use various gears that move by rotary motion when engaged with the rack gear.

The first driving part 422 may include one of a group consisting of multiple links, rack and pinion gears, piston and cylinder, or a linear motor, and be connected to the first connection part 421 to selectively raise and lower the first connection part 421, so that the first connection part 421 is engaged with the first gear part 110 of the first rail 100. Furthermore, the first driving part 422 may further include a motor, and the motor may transmit a rotary force to the first connection part 421.

As described above, the first transfer unit 420 moves linearly along the first rail 100 as the first connection part 421 is selectively engaged with the first gear part 110 by the first driving part 422, thereby transferring the auxiliary device 400 from the first rail 100.

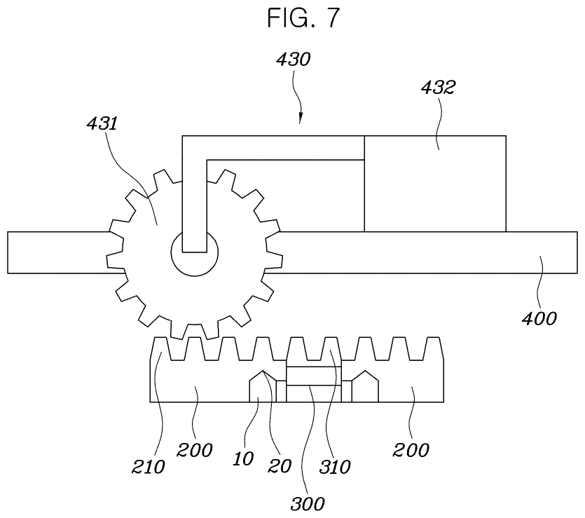

Furthermore, as shown in FIG. 7, the second transfer unit 430 includes the second connection part 431 and the second driving part 432. The second connection part 431 may be rotatably engaged with the second gear part 210 of the second rail 200, and the second driving part 432 may be configured so that the second connection part 431 is selectively engaged with the second gear part 210.

The second gear part 210 may be a rack gear in one example of the present disclosure, and the second connection part 431 may be a gear moving by rotary motion while being engaged with the rack gear. Accordingly, the second connection part 431 may be a helical gear, a pinion gear, or a screw gear like the first connection part 421.

The second driving part 432 may include one of a group consisting of multiple links, rack and pinion gears, piston and cylinder, or a linear motor, and is connected to the second connection part 431 to selectively raise and lower the second connection part 431, so that the second connection part 431 is engaged with the second gear part 210 of the second rail 200. Furthermore, the second driving part 432 may further include a motor, and the motor may transfer a rotary force to the second connection part 431.

As described above, the second transfer unit 430 moves linearly along the second rail 200 as the second connection part 431 is selectively engaged with the second gear part 210 by the second driving part 432, thereby transferring the auxiliary device 400 from the second rail 200.

As described above, the auxiliary device 400 may move selectively along the first rail 100 or the second rail 200 by the first transfer unit 420 and the second transfer unit 430, so that the auxiliary device 400 may move along each rail to various locations on the bottom 30 of a mobility vehicle.

The first transfer unit 420 and the second transfer unit 430 may use various means that move selectively along a specific path in addition to the above-described embodiment, and a user can directly operate the transfer unit 410, or a controller may automatically control the transfer unit 410, changing the location of the auxiliary device 400.

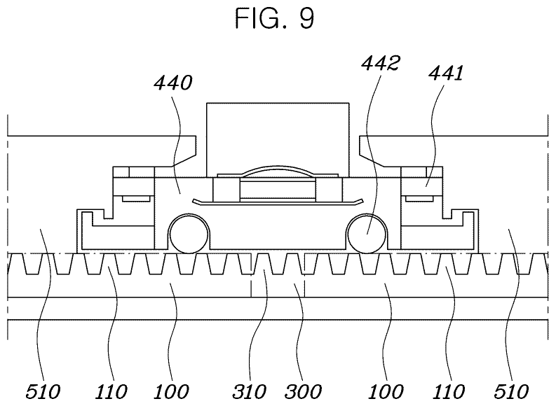

As shown in FIG. 2 and FIG. 9, the bottom 30 may include a path part 500 extending along a direction of the first rail 100 and the second rail 200, and the auxiliary device 400 may include a moving member 440 moving along the path part 500.

The path part 500 may be a portion depressed from, or recessed in, the bottom 30, and provide a space (i.e., a groove or channel) where the first rail 100 and the second rail 200 are provided, and extend along the bottom 30 to match the first rail 100 and the second rail 200. Furthermore, the path part 500 may be separately manufactured and then installed at (i.e., on or in) the bottom 30, and configured such that the first rail 100 and the second rail 200 are provided therein.

The moving member 440 is installed at the auxiliary device 400 and movable along the path part 500. The moving member 440 is provided at a lower portion of the auxiliary device 400, and supports the auxiliary device 400 and moves along the path part 500, so that the location of the auxiliary device 400 is changed. The moving member 440 may include multiple moving members 440 provided in the auxiliary device 400.

The path part 500 may have a height from the bottom 30 higher than the first rail 100, the second rail 200, and the connecting block 300. Accordingly, the moving member 440 may move along the path part 500 without interference with each rail and the connecting block 300.

The path part 500 includes a pair of wall parts 510, and the wall parts 510 may provide a path in which the moving member 440 is movable.

As shown in FIG. 9, the path part 500 includes a pair of wall parts 510 disposed to face each other, and a gap space between the wall parts 510 provides a path along which the moving member 440 is movable. Furthermore, the first rail 100 or the second rail 200 may be provided on a lower surface between the wall parts 510. Each wall part 510 is fixed to the bottom 30, and may be coupled to a panel that constitutes the indoor bottom 30.

A circumferential surface of the moving member 440 includes multiple damping parts 441, and at least one of the damping parts 441 may come into contact with each wall part 510 of the path part 500.

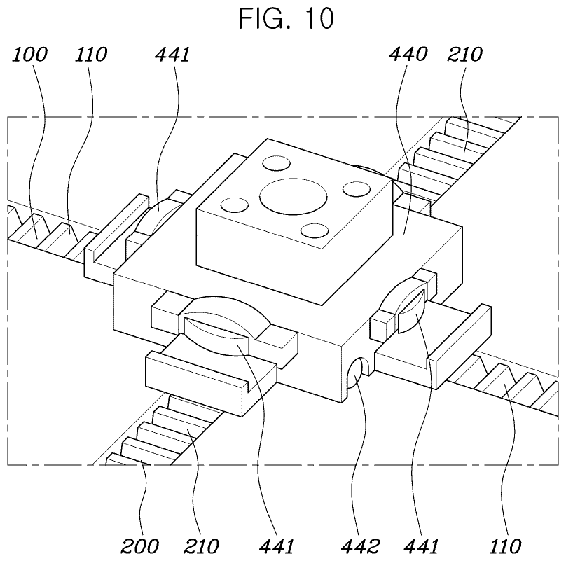

As shown in FIG. 9 and FIG. 10, as the circumferential surface of the moving member 440 includes the multiple damping parts 441 that are disposed to be spaced from each other, each of the damping parts 441 is provided between the moving member 440 and each wall part 510, and may reduce a gap between the moving member 440 and the wall parts 510 and dampen an impact. As shown in FIG. 10, the wall parts 510 are omitted.

In the present disclosure, as the first rail 100 and the second rail 200 extend orthogonally to each other, the damping parts 441 may be disposed at a 90° angle on the circumferential surface of the moving member 440. Of course, the damping parts 441 are not limited thereto, and may be applied variously depending on the number and the installing location of each rail.

As described above, with the damping parts 441 provided at the moving member 440, when the moving member 440 moves along the path part 500, the damping parts 441 provide an elastically supporting structure against the wall parts 510 of the path part 500 to ensure structural stability, and vibrations transmitted through the wall parts 510 are dampened to eliminate inconvenience of using the auxiliary device 400.

Furthermore, the damping parts 441 are configured to be elastically deformable. However, since the damping parts 441, which are made of a high-friction material such as a rubber material, disturb the movement of the moving member 440, the damping parts 441 may be configured to generate elasticity with deformation of the shapes thereof. For example, the damping parts 441 may be curved protrusions at portions that come into contact with the wall parts 510, and the curved shapes may reduce contact areas with the wall parts 510 and dampen impacts by shape deformation. Furthermore, the curved protruding shapes of the damping parts 441 are effective in filling the gap between the moving member 440 and each wall part 510.

The moving member 440 may include a rolling part 442 on a lower surface thereof, the rolling part 442 being rotatable in at least one direction and configured to roll on the bottom 30. The rolling part 442 may be a cylindrical or round bearing and be provided on the lower surface of the moving member 440 to support the moving member 440 against the bottom 30.

According to the above-described multipurpose module for a mobility vehicle of the present disclosure, the location of the auxiliary device 400, such as seats or racks, is changed to various locations inside the mobility vehicle along the path part 500 so that the use convenience of the auxiliary device 400 is improved. Furthermore, the passenger can freely change the indoor space of the mobility vehicle (by changing the location of the auxiliary device 400) to increase indoor space utilization so that the productivity of the mobility vehicle can be improved.

Although the specific embodiments of the present disclosure have been provided, it should be apparent to one of ordinary skill in the art that the present disclosure may be changed and modified in various ways without departing from the scope of the present disclosure, which is provided in the following claims.

What is claimed is:

1. A multipurpose module for a mobility vehicle, the multipurpose module comprising:
a first rail providing a first path on which a transfer unit installed at an auxiliary device is movable in a first direction;
a second rail providing a second path on which the transfer unit is movable in a second direction different from the first direction of the first rail, the second rail being disposed to create a connection point with the first rail; and
a connecting block provided at the connection point of the first rail and the second rail and connecting the first rail and the second rail to each other, thereby allowing the transfer unit to move in an extension direction of the first rail and an extension direction of the second rail.

2. The multipurpose module of claim 1, wherein the first rail and the second rail extend in directions orthogonally to each other.

3. The multipurpose module of claim 1, wherein the connecting block is disposed at the connection point, in which an end portion of the first rail and an end portion of the second rail match each other, and a portion of a circumferential surface of the connecting block overlaps with the end portion of the first rail and the end portion of the second rail.

4. The multipurpose module of claim 3, wherein the connecting block comprises coupling portions on the circumferential surface thereof, and wherein the coupling portions are configured to be coupled to the first rail and the second rail and extend into lower portions of the end portion of the first rail and the end portion of the second rail.

5. The multipurpose module of claim 4, wherein the lower portions of the end portions of the first rail and the second rail are recessed to form coupling grooves, and
the coupling portions of the connecting block are configured to be inserted into the coupling grooves below the end portion of the first rail and the end portion of the second rail.

6. The multipurpose module of claim 5, wherein contact portions of the coupling grooves and the coupling portions are formed into angulated or curved shapes.

7. The multipurpose module of claim 1, wherein the first rail is disposed at an indoor bottom portion of the mobility vehicle and includes a first gear part formed at an upper portion to guide the transfer unit to move in the extension direction of the first rail,
the second rail is installed at the indoor bottom portion of the mobility vehicle and includes a second gear part formed at an upper portion to guide the transfer unit to move in the extension direction of the second rail, and
the connecting block comprises a third gear part connecting the first gear part and the second gear part to each other.

8. The multipurpose module of claim 7, wherein each of the first gear part and the second gear part extends in a direction crossing the extension direction of each rail, and
the third gear part protrudes in a grid shape with intervals, inside the connecting block.

9. The multipurpose module of claim 8, wherein the first gear part and the second gear part have sectional shapes with inclined side surfaces, and
the third gear part has a section in the extension direction of the first rail and a section in the extension direction of the second rail, and the sections are formed equal to each other.

10. The multipurpose module of claim 7, wherein the transfer unit comprises a first transfer unit connected to the first gear part and configured to move along the first rail, and a second transfer unit connected to the second gear part and configured to move along the second rail.

11. The multipurpose module of claim 10, wherein the first transfer unit comprises a first connection part engaged with the first gear part and a first driving part configured to selectively move the first connection part so that the first connection part is selectively engaged with the first gear part, and
the second transfer unit includes a second connection part engaged with the second gear part and a second driving part configured to selectively move the second connection part so that the second connection part is selectively engaged with the second gear part.

12. The multipurpose module of claim 11, wherein the first gear part and the second gear part comprise rack gears, and
the first connection part and the second connection part comprise at least one of helical gears, screw gears, or pinion gears.

13. The multipurpose module of claim 1, wherein at an indoor bottom portion of the mobility vehicle, a plurality of installation holes is formed at positions where extension paths of the first rail and the second rail are provided and where the connecting block is provided,
lower surfaces of the first rail, the second rail, and the connecting block include fastening holes that match the installation holes, and
fixing pins are configured to be inserted into the installation holes and the fastening holes so that the first rail, the second rail, and the connecting block are fixed to the indoor bottom portion of the mobility vehicle.

14. The multipurpose module of claim 1, wherein an indoor bottom portion of the mobility vehicle includes a path part extending along the extension direction of the first rail and the extension direction of the second rail, and
the auxiliary device comprises a moving member configured to move along the path part.

15. The multipurpose module of claim 14, wherein the path part includes a pair of wall parts, and the pair of wall parts provides a path along which the moving member is movable between the wall parts.

16. The multipurpose module of claim 15, wherein the moving member includes a plurality of damping parts on a circumferential surface thereof, and at least one damping part is configured to come into contact with each wall part of the path part.

17. The multipurpose module of claim 14, wherein a lower surface of the moving member comprises a rolling part which is rollable in at least one direction to roll on the indoor bottom portion of the mobility vehicle.

18. The multipurpose module of claim 14, wherein the path part has a height formed from the indoor bottom portion of the mobility vehicle higher than the first rail, the second rail, and the connecting block.
